(19) United States
(12) Patent Application Publication
(10) Pub. No.: US 2020/0294209 A1
(43) Pub. Date: Sep. 17, 2020

(54) CAMERA FEATURE REMOVAL FROM STEREOSCOPIC CONTENT

(71) Applicant: Intel Corporation, Santa Clara, CA (US)

(72) Inventor: Daniel Pohl, Puchheim (DE)

(73) Assignee: Intel Corporation, Santa Clara, CA (US)

(21) Appl. No.: 16/888,691

(22) Filed: May 30, 2020

(51) Int. Cl. G06T 5/00; H04N 13/344; G02B 27/00

(52) U.S. Cl. CPC G06T 5/006; G06T 5/005; G02B 27/0025; H04N 13/344

(57) ABSTRACT

In stereoscopic cameras with wide fields of view, portions of the camera's lenses can be captured in stereoscopic content captured by the camera. These lens artifacts can be distracting to a viewer of the captured stereoscopic content. Revised stereoscopic content can be generated in which the lens artifacts in the left and right images of the stereoscopic content are replaced with image content that blends in with the remainder of the images. With the lens artifacts removed, revised stereoscopic content provides for a more immersive viewing experience to a viewer. A lens artifact in one image of a stereoscopic image can be replaced by image data generated by an inpainting model, interpolated from a portion of the image region around the lens artifact, or based on the corresponding region of the other image in the stereoscopic image. Lens masks can define the portion of an image to be replaced.

### BACKGROUND

Stereoscopic images create the perception of depth by presenting slightly different versions of an image to the left and right eyes of a user. Typically, the differences between the images are the horizontal location of objects in the images. When processed by the brain, these location differences create the perception of depth. Stereoscopic images and videos are often used in augmented reality and virtual reality applications.

### BRIEF DESCRIPTION OF THE DRAWINGS

FIG. 1 is a block diagram of a first exemplary computing device.

FIGS. 2A-2C illustrate top, front, and side views of an exemplary stereoscopic camera.

FIG. 3A illustrates an exemplary stereoscopic image.

FIG. 3B shows a magnified version of the inset of FIG. 3A.

FIG. 4 is a portion of a left image of an exemplary stereoscopic image.

FIGS. 5A & 5B illustrate exemplary lens masks.

FIG. 6 is a first exemplary stereoscopic content generation method.

FIG. 7 is a second exemplary stereoscopic content generation method.

FIG. 8 is a stereoscopic content display method.

FIG. 9 is a block diagram of a second exemplary computing device.

FIG. 10 is a block diagram of a third exemplary computing device.

FIG. 11 is a block diagram of an exemplary processor core.

### DETAILED DESCRIPTION

Images or videos containing depth cues can make them appear more realistic. For example, a rendered virtual reality (VR) environment in which objects located further away from a viewing location appear further away from a viewer can result in a more immersive VR experience. Generation of 360-degree content for VR applications is of interest given its wide field of view, but some existing mechanisms for 360-degree VR content capture provide limited depth cues. VR content generated by such mechanisms can thus result in a less immersive experience. Such approaches typically have the additional drawback that individual images need to be stitched together before the VR content can be viewed.

Devices exist that can generate stereoscopic content with a wide field of view. For example, devices compliant with the VR180 format can generate stereoscopic content having a horizontal field of view of substantially 180 degrees. This horizontal field of view is wider than that of typical existing head-mounted devices (HMDs). As such, a user can move their head to the left or to the right to an extent to see new content while viewing such stereoscopic content on typical HMDs, similar to how new content is observed in the real world.

One consequence of using a wide-angle camera to generate stereoscopic content is that a portion of one stereoscopic lens can be captured in images taken using the other lens. That is, the left image of a stereoscopic image can contain a portion of the right lens of the camera, and the right image can contain a portion of the left lens. The lens portions captured in the left and right images can be referred to herein as lens artifacts. The presence of lens artifacts in stereoscopic images and videos can result in a less immersive experience to a viewer of the stereoscopic content. They can remind a viewer that they are viewing recorded content and the fact that a lens artifact is not captured in both the left and right images can leave a viewer feeling disoriented. Narrowing the field of view of a stereoscopic camera may reduce or eliminate the presence of lens artifacts, but this gain comes at the cost of a narrower field of view. The technologies described herein remove lens artifacts from stereoscopic images and replace them with image data that blends in with the remainder of the image while retaining the camera's full field of view. The technologies described herein can remove lens artifacts from stereoscopic videos as well as stereoscopic images.

In the following description, specific details are set forth, but embodiments of the technologies described herein may be practiced without these specific details. Well-known circuits, structures, and techniques have not been shown in detail to avoid obscuring an understanding of this description. “An embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact. Terms modified by the word “substantially” include arrangements, orientations, spacings, or positions that vary slightly from the meaning of the unmodified term. For example, a stereoscopic camera with a field of view of substantially 180 degrees includes cameras that have a field of view within a few degrees of 180 degrees.

The description may use the phrases “in an embodiment,” “in embodiments,” “in some embodiments,” and “in various embodiments,” each of which may refer to one or more of the same or different embodiments. Furthermore, the terms “comprising,” “including,” “having,” and the like, as used with respect to embodiments of the present disclosure, are synonymous.

Reference is now made to the drawings wherein similar or same numbers may be used to designate the same or similar parts in different figures. The use of similar or same numbers in different figures does not mean all figures including similar or same numbers constitute a single or same embodiment. In the following description, for purposes of explanation, numerous specific details are set forth in order to provide a thorough understanding thereof. It may be evident, however, that the embodiments can be practiced without these specific details. In other instances, well-known structures and devices are shown in block diagram form to facilitate a description thereof. The intention is to cover all modifications, equivalents, and alternatives within the scope of the claims.

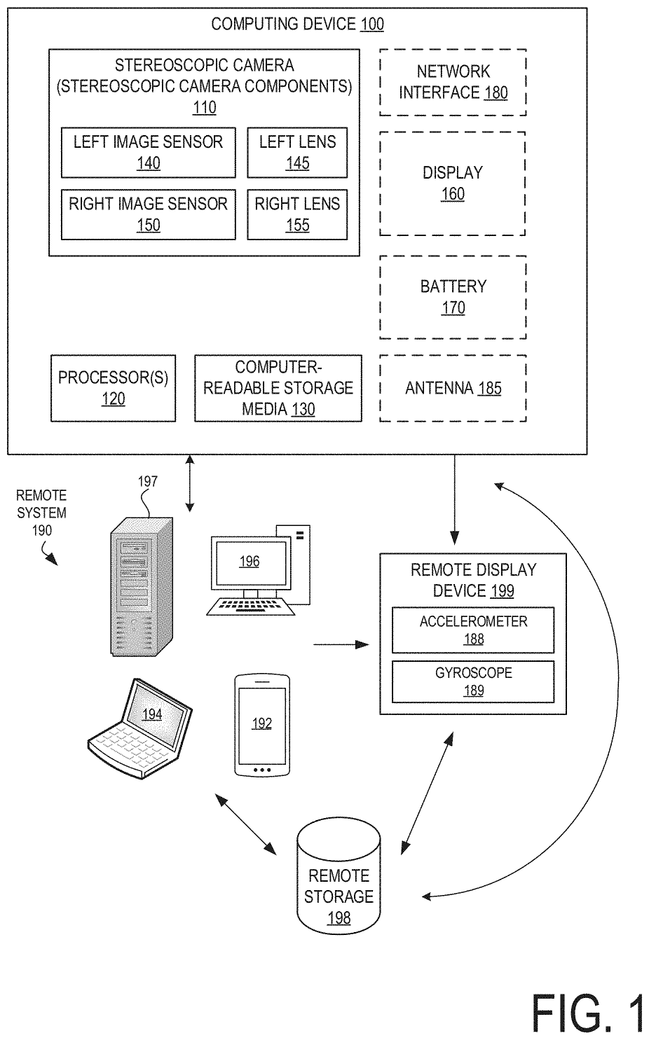

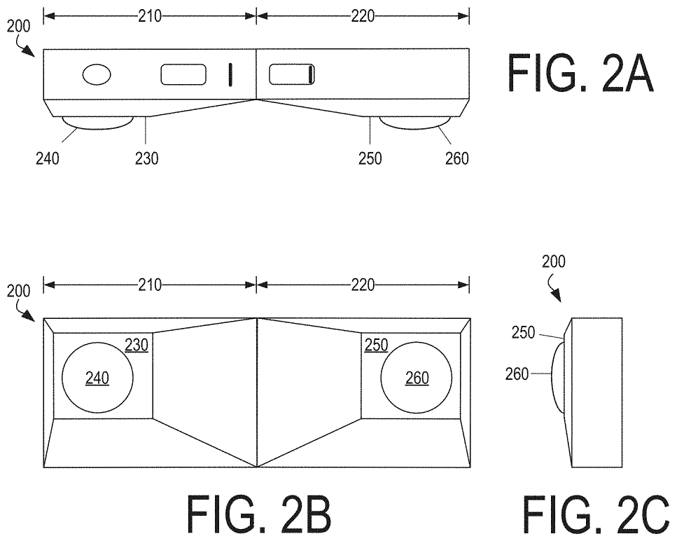

FIG. 1 is a block diagram of a first exemplary computing device in which the technologies described herein may be implemented. The computing device 100 comprises a stereoscopic camera 110, one or more processors 120, and computer-readable storage media 130. The computing device 100 can be any of a wide variety of devices, such as a smartphone, VR headset, HMD, optical head-mounted display (smart glasses), mobile laptop computer, desktop computer, tablet, smart display, security camera, drone, vehicle, or any other device comprising a stereoscopic camera. Although computing device 100 is shown as having the stereoscopic camera 110 as part of the computing device 100, the computing device 100 can be a standalone stereoscopic camera, such as the stereoscopic camera illustrated in FIGS. 2A & 2B. In such embodiments, the stereoscopic camera 110 refers to stereoscopic camera components (e.g., image sensors, lenses).

The computing device 100 can generate stereoscopic images and videos through the use of the stereoscopic camera 110. As used herein, the term “content” can refer to an image, a portion of an image, multiple images, a video, a portion of a video, or multiple videos. The stereoscopic camera 110 comprises a left image sensor 140, a left lens 145, a right image sensor 150, and a right lens 155. The left and right image sensors 140 and 150 produce left and right image sensor data, respectively. Left and right image sensor data are used to generate images from which stereoscopic images or videos can be generated. A stereoscopic image can comprise a left image and a right image. A stereoscopic video comprises a series of stereoscopic images (or frames) and an image in a stereoscopic video comprises a left image and a right image. The series of left images in a stereoscopic video can be referred to as a left video and the series of right images in a stereoscopic video can be referred to as a right video.

In some embodiments, stereoscopic images and videos are generated by the stereoscopic camera 110. In other embodiments, stereoscopic content is generated by the one or more processors 120 based on left and right image sensor data or left and right images provided to the one or more processors 120 by the stereoscopic camera 110. Reference to stereoscopic content that is generated by a stereoscopic camera, generated using a stereoscopic camera, or captured by a stereoscopic camera refers to stereoscopic content that is provided by a stereoscopic camera or stereoscopic content generated by components (e.g., one or more processors 120 of FIG. 1) other than the stereoscopic camera from information provided by a stereoscopic camera, such as image sensor data generated by the stereoscopic camera.

In some embodiments, stereoscopic content comprises digital images and videos and can conform to any image or video format, such as JPEG (Joint Photographic Experts Group), TIFF (Tagged Image File Format), GIF (Graphics Interchange Format), and PNG (Portable Network Graphics) image formats; and AVI (Audio Video Interleave), WMV (Windows Media Video), any of the various MPEG (Moving Picture Experts Group) formats (e.g., MPEG-1, MPEG-2, MPEG-4), QuickTime, and 3GPP (3^{rd} Generation Partnership Project) video formats.

The stereoscopic camera 110 can be incorporated into the computing device 100 (such as in a head-mounted device (HMD), or smartphone) or communicatively coupled to the computing device 100 through a wired or wireless connection. In some embodiments the one or more processors 120 can comprise one or more artificial intelligence (AI) accelerators that implement inpainting models that can generate revised stereoscopic content.

In some embodiments, stereoscopic content can contain portions of the camera 110 that protrude from a camera 110 or device 100 surface. For example, in embodiments where the camera 110 is a wide-angle stereoscopic camera with left and right lenses 145 and 155 that protrude from a front surface of the camera, a portion of the left and right lenses 145 and 155 can be captured in stereoscopic images or videos captured by the camera 110. As will be discussed in greater detail below, the one or more processors 120 can take a stereoscopic image or video containing lens artifacts and generate a revised stereoscopic image or video in which the lens artifacts have been removed and replaced with content that blends in with the remainder of the stereoscopic image or video.

Stereoscopic content and revised stereoscopic content can be stored in the one computer-readable storage media 130, which can be a removable memory card (e.g., Secure Digital (SD) memory card), module, stick, or any other type of removable or non-removable computer-readable storage media described herein. The computing device 100 can further optionally comprise a display 160, a battery 170, a network interface 180, and an antenna 185. In some embodiments, the device 100 is an HMD comprising a screen upon which stereoscopic content can be displayed. In other embodiments, the device 100 is a smartphone and left and right images or left and right videos are shown on left and right portions of the smartphone display, respectively. In such embodiments, the smartphone can be positioned within a virtual reality viewer or other device that, when looked into by a viewer, limits the left eye to see only the left portion of the smartphone display and limits the right eye to see only the right portion. The network interface 180 allows the computing device 100 to communicate in wired or wireless fashion with other computing devices, such remote system 190 or a remote display device 199, using any communication interface, protocol, technology, or combinations thereof. The antenna 185 enables wireless communications between the device 100 and other computing devices.

The computing device 100 can send stereoscopic content to the remote system 190 for the generation of revised stereoscopic content. The remote system 190 can be a smartphone 192, laptop 194, personal computer 196, server 197, or any other computing device. The generation of revised stereoscopic images and videos by the remote system 190 can be performed during the post-processing of stereoscopic content captured by the device 100. That is, the remote system 190 can store the received stereoscopic content and generate revised stereoscopic content at any later time. Revised stereoscopic images and videos generated by the remote system 190 can be sent back to the capturing device (i.e., device 100) or the remote display device 199 for display or storage. Revised stereoscopic content can be sent to a remote storage 198 for later retrieval by any of the devices shown in FIG. 1. The remote display device 199 can be any type of device described or referenced herein that has a display. In some embodiments, the remote display device 199 comprises an accelerometer 188 and a gyroscope 189, which the remote display device 199 can use to determine its orientation.

FIG. 1 thus illustrates various combinations of devices that can be used to capture stereoscopic content, remove lens artifacts from the stereoscopic content to create revised stereoscopic content, and display the revised stereoscopic content. In some embodiments, the computing device 100 performs all three tasks. In other embodiments, the computing device 100 captures stereoscopic images and videos, generates revised stereoscopic images and videos, and sends the revised stereoscopic images and videos to the remote display device 199 for display. In yet other embodiments, the computing device 100 captures stereoscopic content and sends the captured content to the remote system 190. The remote system 190 then generates the revised stereoscopic images and videos and sends the revised stereoscopic content to the remote display device 199 for display. The remote display device 199 can access revised stereoscopic content stored at the remote storage 198 to view the stored stereoscopic content on demand. In some embodiments, revised stereoscopic content received at the remote display device 199 can be stored at the remote display device 199 for later viewing. In some embodiments, revised stereoscopic content can be generated from stereoscopic content stored at a playback device, such as device 100 or remote display device 199, upon playback.

In an embodiment involving all of the devices illustrated in FIG. 1, the computing device 100 can be a stereoscopic camera, the remote system 190 and the remote storage 198 can be part of a cloud-based storage and image processing service, and the remote display device 199 can be an HMD. The stereoscopic camera can capture stereoscopic content and deliver the captured content to the cloud-based service, which removes the lens artifacts and stores the revised stereoscopic content. The HMD retrieves the revised stereoscopic content from the remote storage service where it is displayed at the HMD for viewing.

The display of revised stereoscopic content can be done in real-time or at a later time after capture. As used herein, the term “real-time” when used in the context of displaying revised stereoscopic images refers to displaying revised stereoscopic content at a short enough time after the stereoscopic content has been captured such that a user is likely not to notice the delay between capture and display or that the user does not suffer from motion sickness or any other physical effects due to this delay. For example, in a “see-through” augmented reality (AR) embodiment, an HMD with an integrated stereoscopic camera can generate and display revised stereoscopic content in a short enough time after capture such that the user feels that they are seeing a live view of what the camera is viewing. Additional content can be added to the revised stereoscopic content before being shown on the display to enable augmented reality use cases.

FIGS. 2A-2C illustrate top, front, and side views of an exemplary stereoscopic camera. The stereoscopic camera 200 is a wide-field camera with a field of view of substantially 180 degrees and can generate stereoscopic images and videos. The camera 200 can capture images and videos in a variety of formats, including HDR (high dynamic range). The camera 200 comprises a right portion 210 and a left portion 220. The right portion 210 comprises a right face 230 from which a right lens 240 protrudes and the left portion 220 comprises a left face 250 from which a left lens 260 protrudes. The left lens 260 and the right lens 240 are spaced apart approximately the same distance as a pair of human eyes and the left face 250 and the right face 230 lie in the same plane. As such, the camera 200 captures stereoscopic content in a manner mimicking the way humans view the world. With the camera 200 having a field of view of substantially 180 degrees, a portion of the left lens 260 is included in images or videos captured using the right lens 240 and a portion of the right lens 240 is included in images or videos captured using the left lens 260. In some embodiments, the camera 200 can generate stereoscopic content without having to stitch together individual images or videos before the captured content can be viewed. In some embodiments, the camera 200 can produce stereoscopic content according to the VR180 format.

The camera 200 further comprises a left image sensor associated with the left lens 260 and a right image sensor associated with the right lens 240 (image sensors not shown). The camera 200 further accommodates removable storage media, such as Secure Digital (SD) (e.g., SD, SD High Capacity (SDHC), SD Extended Capacity (SDXC)) or Compact Flash (CF) memory cards for storing stereoscopic content, revised stereoscopic content, or any other content captured or generated by the camera 200. The camera 200 further comprises one or more processors that can process stereoscopic images and videos generated by the camera to produce revised stereoscopic images and videos using the technologies described herein. The camera 200 further comprises a network interface that allows the camera 200 to communicate with other devices via one or more wired or wireless interfaces. The camera 200 further comprises an antenna to enable wireless communication and a rechargeable battery.

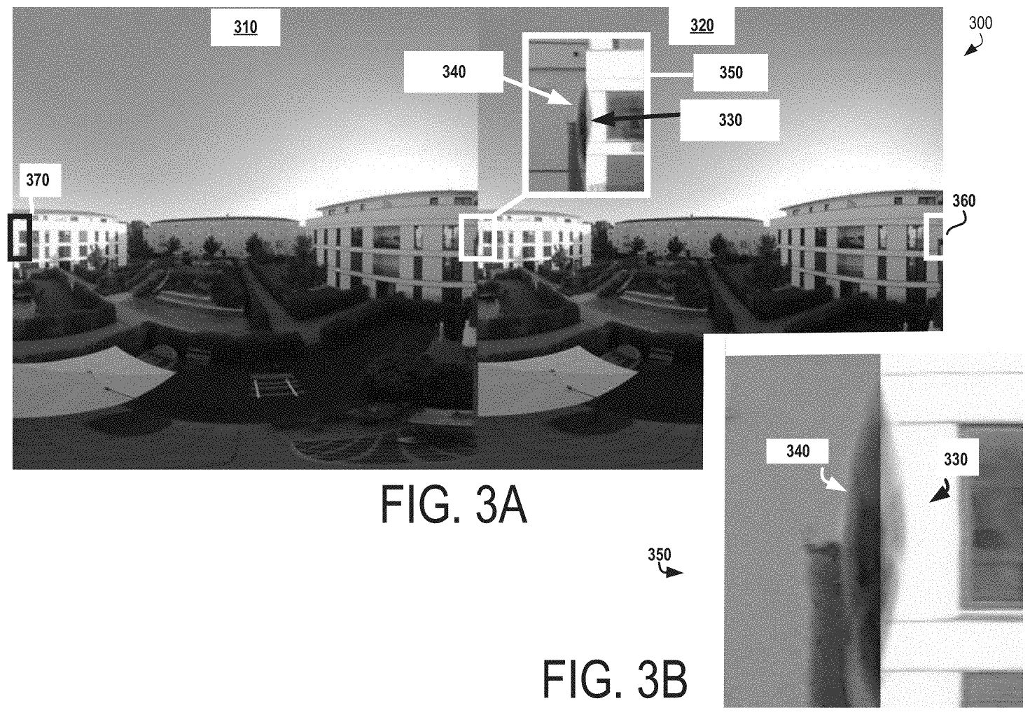

FIG. 3A illustrates an exemplary stereoscopic image. The stereoscope image 300 comprises a left image 310 and a right image 320. A left lens artifact 330 can be seen at the left edge of the right image 320 and a right lens artifact 340 can be seen at the right edge of the left image 310. Inset 350 shows the lens artifacts 330 and 340. FIG. 3B shows a magnified version of the inset 350.

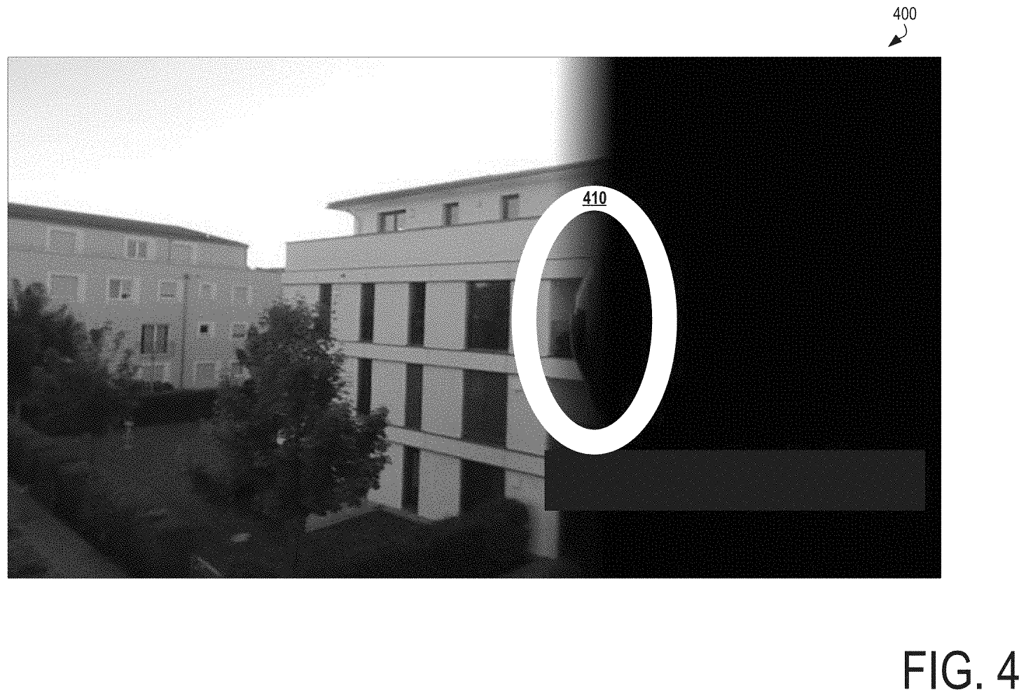

FIG. 4 is a portion of a left image of an exemplary stereoscopic image. The left image portion 400 comprises a right lens artifact 410. FIG. 4 illustrates that the size of a lens artifact can be perceived to be on the scale of adjacent features in the image. For example, the right lens artifact 410 is adjacent to a window of an office building located in the background. The window appears to span most of the height of the third story of the building, and the right lens artifact 410 can thus be perceived to be a meter-sized object. The presence of an artifact with such a large perceived size can be distracting to a viewer and remind them that they are viewing a reproduction of the real world. A viewer of stereoscopic content containing lens artifacts can be further distracted by the fact that artifacts are not captured stereoscopically. That is, the left lens artifact is only captured in the right image and the right lens artifact is only captured in the left image. Having an item in a stereoscopic image presented to one eye and not the other can be disorienting to a user.

The technologies described herein remove lens artifacts captured in stereoscopic images and videos and replace them with content that blends in with the remainder of the image to create revised stereoscopic images and videos. As used herein, the term “blends in” with reference to content that replaces a lens artifact in an image means that the content replacing the lens artifact more closely matches or better fits the image than the lens artifact. In some embodiments, the content replacing a lens artifact can be content that a user would have expected to see had the lens responsible for the artifact had not been in the way. For example, with reference to FIGS. 3A & 3B, the lens artifacts 330 and 340 can be replaced with content that resembles the exterior of a white office building with floor to ceiling windows. The term “blends in” does not mean that the content replacing a lens artifact needs to be a perfect, exact, or even very good match for the remainder of the stereoscopic image. Content replacing a lens artifact blends in with a stereoscopic image or video if it is a closer match or better fit for the stereoscopic image than the replaced lens artifact. As used herein, the term “left image content” refers to content replacing a rights lens artifact in a left image and the term “right image content” refers to content replacing a left lens artifact in a right image.

In some embodiments, a lens artifact is replaced with content that blends in with a stereoscopic image or video via inpainting. As used herein, the term “inpainting” refers to the process of filling in one or more missing portions or replacing one or more portions of an image or video with content generated based on the remainder of the image or video (or a portion thereof). In some embodiments, inpainting is performed using artificial intelligence approaches. For example, an image or image portion with one or more missing portions or portions marked for replacement can be provided as input to a model that can perform inpainting on images and the model can output a revised image with the missing portions filled in or the marked portions replaced with content that blends in with the remainder of the image. Such models can be referred to herein as inpainting models. In this way, revised stereoscopic content can be generated. In some embodiments, an inpainting model can be a trained machine learning model, such as a trained convolutional neural network. In other embodiments, the model can be based on a generative adversarial network (GAN).

In some embodiments, a device that captures stereoscopic content and generates revised stereoscopic content can utilize trained inpainting models to generate revised stereoscopic content. The inpainting models can be implemented in dedicated hardware, such as one or more GPUs (graphics processing units), FPGA (Field Programmable Gate Arrays), or AI accelerators. Such dedicated hardware can be located in any device described or referenced herein that generates revised stereoscopic content.

In some embodiments, performing inpainting on one image (left/right) of a stereoscopic image can be based on a portion of the other image in the stereoscopic image (right/left). This approach takes advantage of the fact that lens artifacts are not captured stereoscopically. For example, a right lens artifact in a left image can be replaced with content based on a portion of the right image that corresponds to where the right lens artifact resides in the left image. Referring back to FIGS. 3A & 3B, the content replacing the right lens artifact 340 can be based on a portion 360 of the right image 320. Similarly, content replacing the left lens artifact 330 can be based on a portion 370 of the left image 310.

In some embodiments, inpainting comprises copying information from one image to another. For example, the left lens artifact 330 in FIG. 3A can be replaced with content from the region 370. In other embodiments, inpainting can comprise transforming content from the image space of a source image (left/right) to the image space of the destination image (right/left). This is due to the left and right lens in a stereoscopic camera being physically offset, typically by a distance roughly equal to the space between the left and right eyes in a human. The transformation can take into account one or more intrinsic or extrinsic values of the stereoscopic lenses, such as focal length, optical center, radial distortion coefficients, and information indicating the orientation (e.g., rotation and translation) of the camera with respect to a world coordinate system. In some embodiments, intrinsic lens values related to distortion effects can be derived from images taken by the camera of calibration patterns, such as checkerboard patterns.

In some embodiments, inpainting comprises providing content taken from a source image to an inpainting model to generate the content to replace a lens artifact. For example, inpainting a left image of a stereoscopic image can comprise providing the left image (or a portion thereof) to an inpainting model and a portion of the right image corresponding to the region of the left image occupied by the right lens artifact.

In embodiments involving the use of inpainting models, only a portion of the image may be provided to the inpainting model. For example, with reference to FIG. 3A, only a portion of the left image 310 may be provided to an inpainting model to replace or remove the right lens artifact 340. In some embodiments, the size of the image portion to provide to an inpainting model can be based on the size of the lens artifact to be removed or replaced. The size of the image portion provided to an inpainting model can depend upon factors such as the size of a left or right image, characteristics of the model (e.g., speed, complexity), and the size of the portions of the image that are missing or are to be replaced to be inpainted. An inpainting model that takes as input a portion of a left or right image may be implemented using fewer computing resources or be faster than a model that takes an entire left or right image as input.

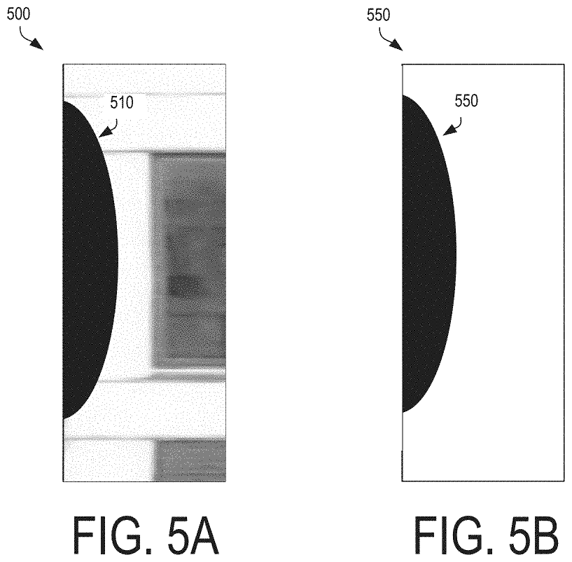

In some embodiments, the portion of an image to be inpainted can be defined by a mask. FIGS. 5A & 5B illustrate exemplary lens masks. Image portion 500 shows a portion of the right image 320 of FIGS. 3A & 3B and comprises a left lens mask 510. The left lens mask 510 identifies a region of the right image 320 to be inpainted.

In some embodiments, as the location, size, and shape of a lens artifact in stereoscopic content are fixed for a particular camera, the shape, size, and location of a lens mask for the particular camera can be fixed as well. Lens mask information can identify a lens mask in various fashions. For example, lens mask information can comprise a plurality of (x,y) coordinates that define a polygon. Although the mask 510 in FIG. 5 is a partial ellipse in shape and generally tracks the shape of the left lens artifact 330, a lens mask can take any shape. In some embodiments, the mask can be a rectangle defined by a set of (x,y) coordinates or by an origin (x,y) coordinates and height and width dimensions.

In other examples, a mask can be a lens mask image in which pixels having one or more specified characteristics specify the region to be filled in or replaced during inpainting. For example, mask 550 of FIG. 5B is an image in which dark pixels 560 indicate the pixels that are to be replaced during inpainting. In some embodiments, a lens mask image can be combined (e.g., via a logical OR operation) with an image to be inpainted and the resulting combined image can be provided to an inpainting model. In other embodiments, an image to be inpainted and a lens mask image can be provided separately to an inpainting model. In yet other embodiments, a region of an image can be removed based on a lens mask and the resulting image with a missing portion to be filled can be provided to an inpainting model.

In some embodiments, lens mask information can be stored with stereoscopic content for use during post-processing or playback. Lens mask information can be stored as part of the stereoscopic content as metadata or otherwise. In some embodiments, lens mask information can be provided to a device that is to generate revised stereoscopic content, such as the remote system 190 in FIG. 1.

In some embodiments, stereoscopic content is played back on a device with a display having a field of view less than that of the stereoscopic content. For example, existing HMDs or other VR viewers generally have a field of view (FOV) that is narrower than wide-angle stereoscopic cameras, such as cameras conforming to the VR180 format. If a user is viewing stereoscopic content having a FOV greater than the display FOV of the device showing the stereoscopic content, lens artifacts would be displayed when the viewer looks to the far left (and would see the left lens artifact in the right image with their right eye) or to the far right (and would see the right lens artifact in the left image with their left eye). Lens artifacts would not be displayed when a viewer is looking generally straight ahead or moves their head to the left or the right within a certain range from center. In such embodiments, a device can generate and display revised stereoscopic content if it determines that regions of stereoscopic content containing lens artifacts would otherwise be shown on the display. In some embodiments, a device can make such a determination based on the orientation of the viewing device. The orientation of a viewing device can be determined based on sensor data provided by one or more viewing device sensors, such as an accelerometer or gyroscope.

As previously discussed, the inpainting of stereoscopic content to remove and replace lens artifacts can be performed locally at a capturing device (e.g., device 100 of FIG. 1) or remotely at a remote device or system (e.g., remote system 190). The generation of revised stereoscopic content can comprise splitting a stereoscopic image into its constituent left and right images, generating revised left and right images using the technologies described herein and recombining the revised left and right images to generate revised stereoscopic content. In some embodiments, lens artifacts are removed from stereoscopic video by converting the video into individual frames, removing the lens artifacts from the individual frames, and converting the individual frames back to a video.

In some embodiments, the technologies described herein can be used to remove additional artifacts from stereoscopic content. These additional artifacts can be caused by the presence of camera or device features other than lenses, such as buttons, switches, latches, housing portions, or any other camera or device feature located in the camera's field of view. The technologies disclosed herein can be used to revised stereoscopic content in which these additional artifacts are removed and replaced with content that blends with the stereoscopic content.

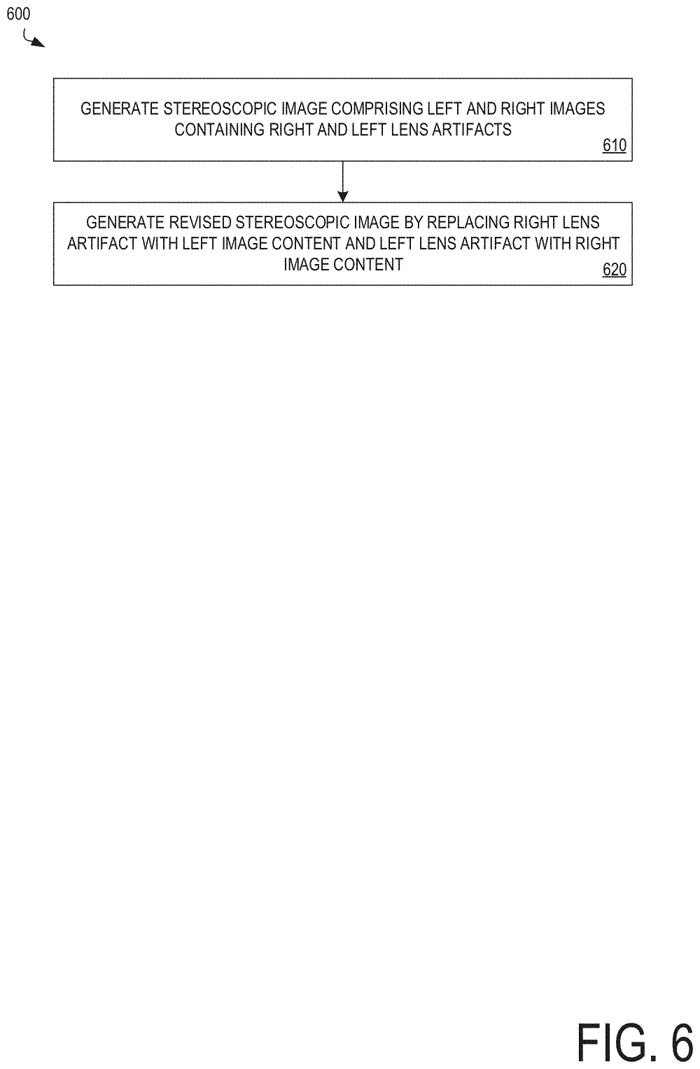

FIG. 6 illustrates an exemplary stereoscopic content generation method. The method 600 can be performed by, for example, an HMD with an integrated stereoscopic camera that conforms to the VR180 format. At 610, a stereoscopic image is generated using a stereoscopic camera. The stereoscopic image comprises a left image and a right image. The left image includes a right lens artifact and the right image includes a left lens artifact. At 620, a revised stereoscopic image is generated by replacing the right lens artifact with left image content that blends in with the left image and replacing the left lens artifact with right image content that blends in with the right image. In other embodiments, the exemplary methods illustrated in FIG. 6 can comprise fewer, alternative, or more actions than those shown and described above. For example, the method 600 can further comprise displaying the revised stereoscopic content on a display.

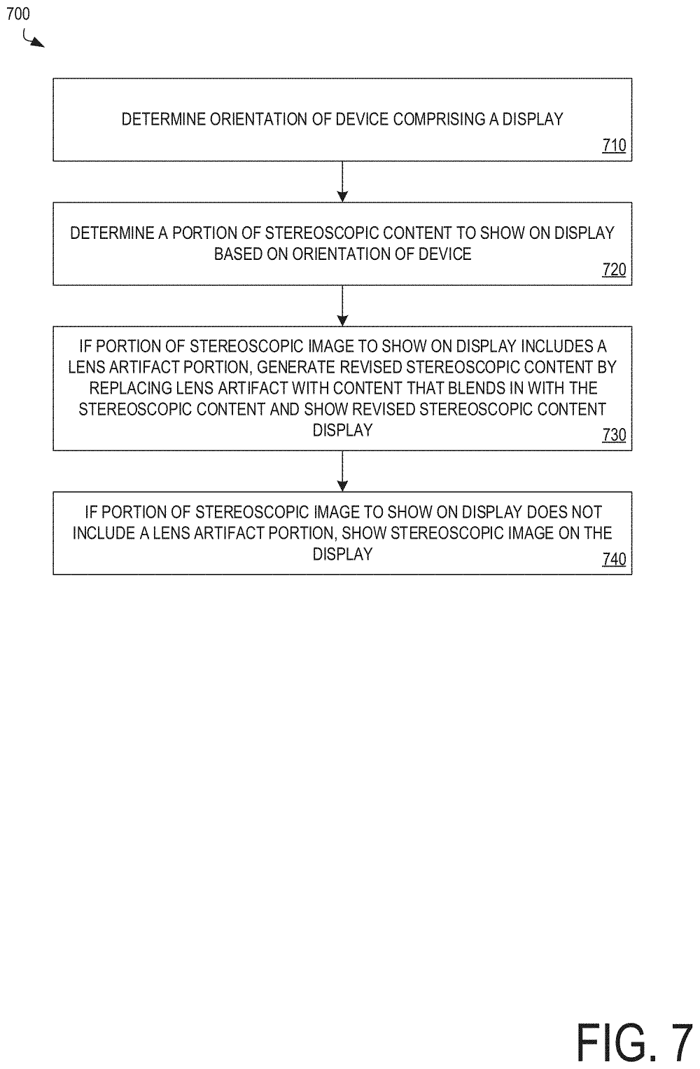

FIG. 7 is a second exemplary stereoscopic content generation method. The method 700 can be performed by, for example, an HMD that is displaying stereoscopic content. At 710, an orientation of a device comprising a display having a display field of view (FOV) is determined. At 720, a portion of stereoscopic content to be shown on the display is determined based on the orientation of the device, the stereoscopic content having a stereoscopic content FOV greater than the display FOV. At 730, if the portion of the stereoscopic image to be shown on the display includes at least a portion of a lens artifact, revised stereoscopic content is generated by replacing the lens artifact with content that blends in with the stereoscopic content and the revised stereoscopic content is shown on the display instead of the stereoscopic content. At 740, if the portion of the stereoscopic image to be shown on the display does not include at least a portion of the lens artifact, the stereoscopic image is shown on the display.

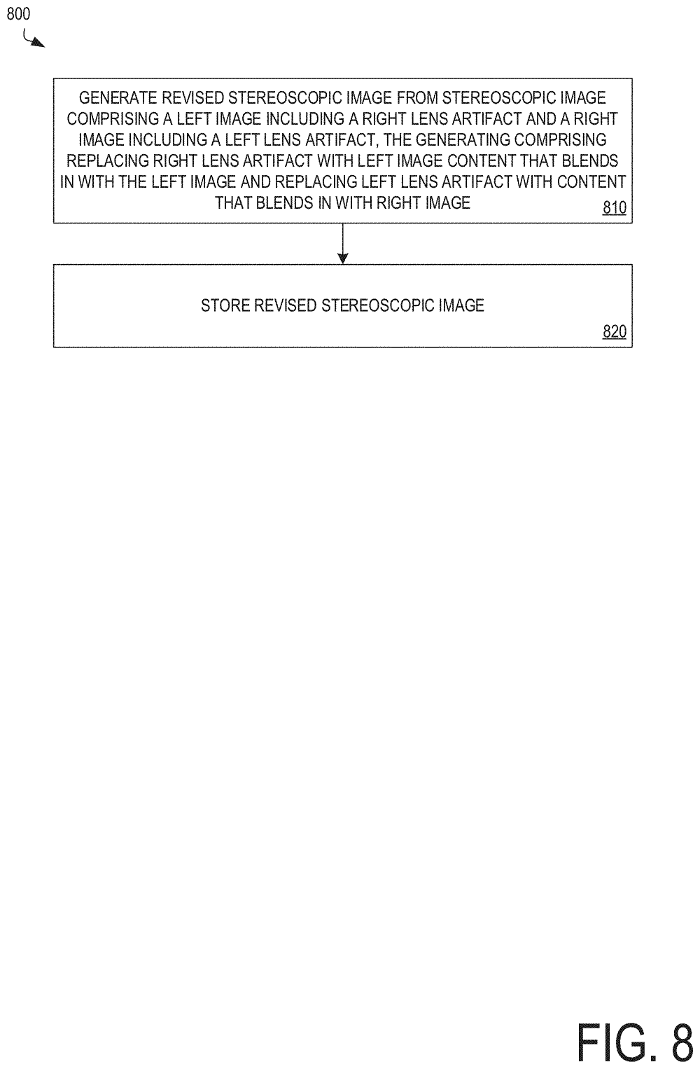

FIG. 8 is a stereoscopic content display method. The method 800 can be performed by, for example, a cloud-based image or video processing service. At 810, a revised stereoscopic image is generated from a stereoscopic image captured with a stereoscopic camera, the stereoscopic image comprising a left image and a right image, the left image including a right lens artifact, the right image including a left lens artifact. The generating comprises replacing the right lens artifact with left image content that blends in with the left image and replacing the left lens artifact with content that blends in with the right image. At 820, the revised stereoscopic image is stored.

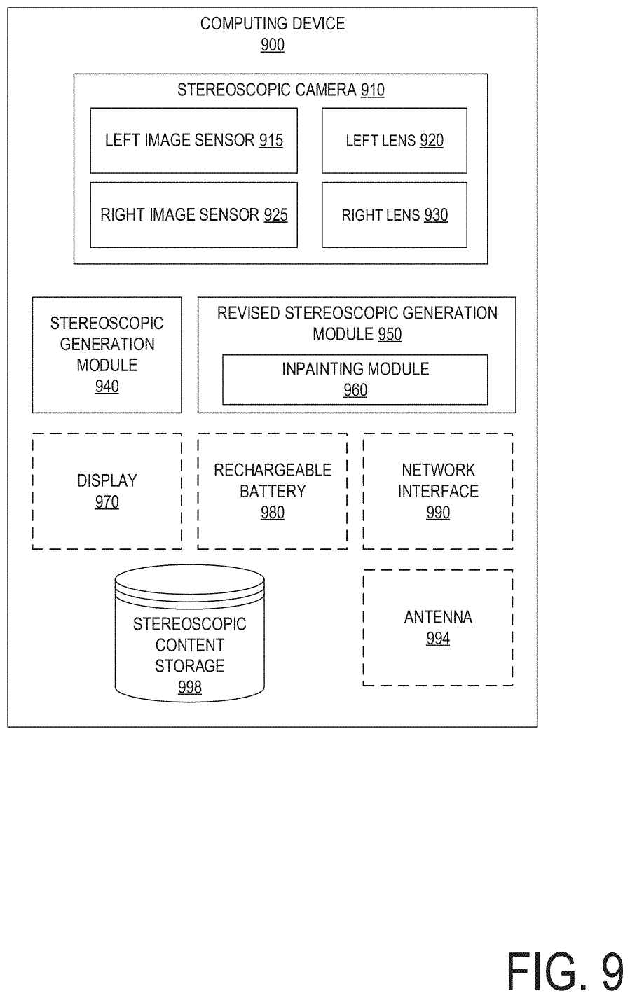

FIG. 9 is a block diagram of a second exemplary computing device 900 in which the technologies described herein may be implemented. The computing device 900 comprises a stereoscopic camera 910 and various modules and additional components. The stereoscopic camera 910 comprises a left image sensor 915 that receives light that passes through a left lens 920 and a right image sensor 925 that receives light that passes through a right lens 930. A stereoscopic generation module 940 generates stereoscopic content based on image sensor data provided by the stereoscopic camera 910. A revised stereoscopic generation module 950 can replace lens artifacts in stereoscopic content with image content that blends in with the remainder of the stereoscopic content. The revised stereoscopic generation module 950 comprises an inpainting module 960 that can be utilized to replace the lens artifacts in stereoscopic content using any of the inpainting approaches described or referenced herein. The computing device 900 further comprises a display 970, a rechargeable battery 980, a network interface 990, an antenna 994, and a stereoscopic content storage 998. The storage 998 can store stereoscopic content generated by stereoscopic generation module 940, or revised stereoscopic generation module 950, lens mask information, or any other information generated or used by the computing device 900.

FIG. 9 illustrates one example of a set of modules that can be included in a computing device in which the technologies described herein may be implemented. In other embodiments, a computing device can have more or fewer modules than those shown in FIG. 9. Further, separate modules can be combined into a single module, and single module can be split into multiple modules. Moreover, any of the modules shown in FIG. 9 can be part of the operating system of the computing device 900, one or more software applications independent of the operating system, or operate at another software layer. The modules shown in FIG. 9 can be implemented in software, hardware, firmware, or combinations thereof. A computer device referred to as being programmed to perform a method can be programmed to perform the method via software, hardware, firmware, or combinations thereof.

The technologies, techniques, and embodiments described herein can be performed by any of a variety of computing devices, including mobile devices (e.g., smartphones, handheld computers, tablet computers, laptop computers, media players, portable gaming consoles, cameras and video recorders, wearables (e.g., smartwatches)), non-mobile devices (e.g., desktop computers, servers, stationary gaming consoles, set-top boxes, smart televisions); embedded devices (e.g., devices incorporated into a vehicle, home or place of business); and any other device described or referenced to herein. As used herein, the term “computing device” includes computing systems and includes devices comprising multiple discrete physical components.

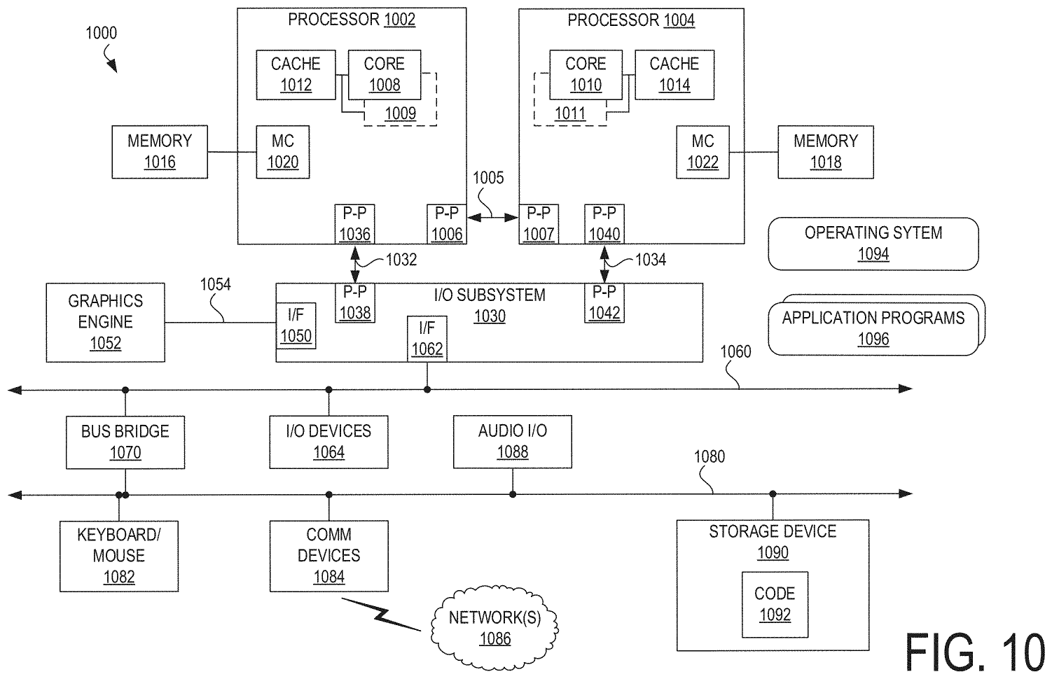

FIG. 10 is a block diagram of a third exemplary computing device 1000 in which technologies described herein may be implemented. Generally, components shown in FIG. 10 can communicate with other shown components, although not all connections are shown, for ease of illustration. The device 1000 is a multiprocessor system comprising a first processor 1002 and a second processor 1004 and is illustrated as comprising point-to-point (P-P) interconnects. For example, a point-to-point (P-P) interface 1006 of the processor 1002 is coupled to a point-to-point interface 1007 of the processor 1004 via a point-to-point interconnection 1005. It is to be understood that any or all of the point-to-point interconnects illustrated in FIG. 10 can be alternatively implemented as a multi-drop bus and that any or all buses illustrated in FIG. 10 could be replaced by point-to-point interconnects.

As shown in FIG. 10, the processors 1002 and 1004 are multicore processors. Processor 1002 comprises processor cores 1008 and 1009, and processor 1004 comprises processor cores 1010 and 1011. Processor cores 1008-1011 can execute computer-executable instructions in a manner similar to that discussed below in connection with FIG. 13, or in other manners.

Processors 1002 and 1004 further comprise at least one shared cache memory 1012 and 1014, respectively. The shared caches 1012 and 1014 can store data (e.g., instructions) utilized by one or more components of the processor, such as the processor cores 1008-1009 and 1010-1011. The shared caches 1012 and 1014 can be part of a memory hierarchy for the device 1000. For example, the shared cache 1012 can locally store data that is also stored in a memory 1016 to allow for faster access to the data by components of the processor 1002. In some embodiments, the shared caches 1012 and 1014 can comprise multiple cache layers, such as level 1 (L1), level 2 (L2), level 3 (L3), level 4 (L4), and/or other caches or cache layers, such as a last level cache (LLC).

Although the device 1000 is shown with two processors, the device 1000 can comprise any number of processors. Further, a processor can comprise any number of processor cores. A processor can take various forms such as a central processing unit, a controller, a graphics processor, an accelerator (such as a graphics accelerator, digital signal processor (DSP), or AI accelerator) or a field programmable gate array (FPGA). A processor in a device can be the same as or different from other processors in the device. In some embodiments, the device 1000 can comprise one or more processors that are heterogeneous or asymmetric to a first processor, accelerator, FPGA, or any other processor. There can be a variety of differences between the processing elements in a system in terms of a spectrum of metrics of merit including architectural, microarchitectural, thermal, power consumption characteristics and the like. These differences can effectively manifest themselves as asymmetry and heterogeneity amongst the processors in a system. In some embodiments, the processors 1002 and 1004 reside in the same die package.

Processors 1002 and 1004 further comprise memory controller logic (MC) 1020 and 1022. As shown in FIG. 10, MCs 1020 and 1022 control memories 1016 and 1018 coupled to the processors 1002 and 1004, respectively. The memories 1016 and 1018 can comprise various types of memories, such as volatile memory (e.g., dynamic random-access memories (DRAM), static random-access memory (SRAM)) or non-volatile memory (e.g., flash memory, solid-state drives, chalcogenide-based phase-change non-volatile memories). While MCs 1020 and 1022 are illustrated as being integrated into the processors 1002 and 1004, in alternative embodiments, the MCs can be logic external to a processor, and can comprise one or more layers of a memory hierarchy.

Processors 1002 and 1004 are coupled to an Input/Output (I/O) subsystem 1030 via P-P interconnections 1032 and 1034. The point-to-point interconnection 1032 connects a point-to-point interface 1036 of the processor 1002 with a point-to-point interface 1038 of the I/O subsystem 1030, and the point-to-point interconnection 1034 connects a point-to-point interface 1040 of the processor 1004 with a point-to-point interface 1042 of the I/O subsystem 1030. Input/Output subsystem 1030 further includes an interface 1050 to couple I/O subsystem 1030 to a graphics engine 1052, which can be a high-performance graphics engine. The I/O subsystem 1030 and the graphics engine 1052 are coupled via a bus 1054. Alternately, the bus 1054 could be a point-to-point interconnection.

Input/Output subsystem 1030 is further coupled to a first bus 1060 via an interface 1062. The first bus 1060 can be a Peripheral Component Interconnect (PCI) bus, a PCI Express bus, another third generation I/O interconnection bus or any other type of bus.

Various I/O devices 1064 can be coupled to the first bus 1060. A bus bridge 1070 can couple the first bus 1060 to a second bus 1080. In some embodiments, the second bus 1080 can be a low pin count (LPC) bus. Various devices can be coupled to the second bus 1080 including, for example, a keyboard/mouse 1082, audio I/O devices 1088 and a storage device 1090, such as a hard disk drive, solid-state drive or other storage device for storing computer-executable instructions (code) 1092. The code 1092 can comprise computer-executable instructions for performing technologies described herein. Additional components that can be coupled to the second bus 1080 include communication device(s) 1084, which can provide for communication between the device 1000 and one or more wired or wireless networks 1086 (e.g. Wi-Fi, cellular or satellite networks) via one or more wired or wireless communication links (e.g., wire, cable, Ethernet connection, radio-frequency (RF) channel, infrared channel, Wi-Fi channel) using one or more communication standards (e.g., IEEE 1002.11 standard and its supplements).

The device 1000 can comprise removable memory such as flash memory cards (e.g., SD (Secure Digital) cards), memory sticks, Subscriber Identity Module (SIM) cards). The memory in device 1000 (including caches 1012 and 1014, memories 1016 and 1018 and storage device 1090) can store data and/or computer-executable instructions for executing an operating system 1094 and application programs 1096. Example data includes web pages, text messages, images, sound files, video data, stereoscopic images or videos, or other data to be sent to and/or received from one or more network servers or other devices by the device 1000 via one or more wired or wireless networks, or for use by the device 1000. The device 1000 can also have access to external memory (not shown) such as external hard drives or cloud-based storage.

The operating system 1094 can control the allocation and usage of the components illustrated in FIG. 10 and support one or more application programs 1096. The application programs 1096 can include common mobile computing device applications (e.g., email applications, calendars, contact managers, web browsers, messaging applications) as well as other computing applications, such as virtual reality viewers that can view stereoscopic content.

The device 1000 can support various input devices, such as a touchscreen, microphone, monoscopic camera, stereoscopic camera, trackball, touchpad, trackpad, mouse, keyboard, proximity sensor, light sensor, electrocardiogram (ECG) sensor, PPG (photoplethysmogram) sensor, galvanic skin response sensor, and one or more output devices, such as one or more speakers or displays. Other possible input and output devices include piezoelectric and other haptic I/O devices. Any of the input or output devices can be internal to, external to or removably attachable with the device 1000. External input and output devices can communicate with the device 1000 via wired or wireless connections.

In addition, the computing device 1000 can provide one or more natural user interfaces (NUIs). For example, the operating system 1094 or applications 1096 can comprise speech recognition logic as part of a voice user interface that allows a user to operate the device 1000 via voice commands. Further, the device 1000 can comprise input devices and logic that allows a user to interact with the device 1000 via a body, hand or face gestures. For example, a user's hand gestures can be detected and interpreted to provide input to a gaming application or virtual reality application.

The device 1000 can further comprise one or more communication components 1084. The components 1084 can comprise wireless communication components coupled to one or more antennas to support communication between the system 1000 and external devices. The wireless communication components can support various wireless communication protocols and technologies such as Near Field Communication (NFC), IEEE 1002.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM). In addition, the wireless modems can support communication with one or more cellular networks for data and voice communications within a single cellular network, between cellular networks, or between the mobile computing device and a public switched telephone network (PSTN).

The device 1000 can further include at least one input/output port (which can be, for example, a USB, IEEE 1394 (FireWire), Ethernet and/or RS-232 port) comprising physical connectors, a power supply (such as a rechargeable battery), a satellite navigation system receiver (such as a GPS receiver); a gyroscope; an accelerometer; a proximity sensor; and a compass. A GPS receiver can be coupled to a GPS antenna. The device 1000 can further include one or more additional antennas coupled to one or more additional receivers, transmitters and/or transceivers to enable additional functions.

In wearable embodiments, the device 1000 can comprise attachment mechanisms such as straps, clasps, or frames that allow the device to be attached to a body. In some embodiments, the device 1000 comprises a propulsion system, such as a motor to drive one or more propellers, fans, or wheels.

It is to be understood that FIG. 10 illustrates only one exemplary computing device architecture. Computing devices based on alternative architectures can be used to implement technologies described herein. For example, instead of the processors 1002 and 1004, and the graphics engine 1052 being located on discrete integrated circuits, a computing device can comprise a SoC (system-on-a-chip) integrated circuit incorporating multiple processors, a graphics engine and additional components. Further, a computing device can connect elements via bus or point-to-point configurations different from that shown in FIG. 10. Moreover, the illustrated components in FIG. 10 are not required or all-inclusive, as shown components can be removed and other components added in alternative embodiments.

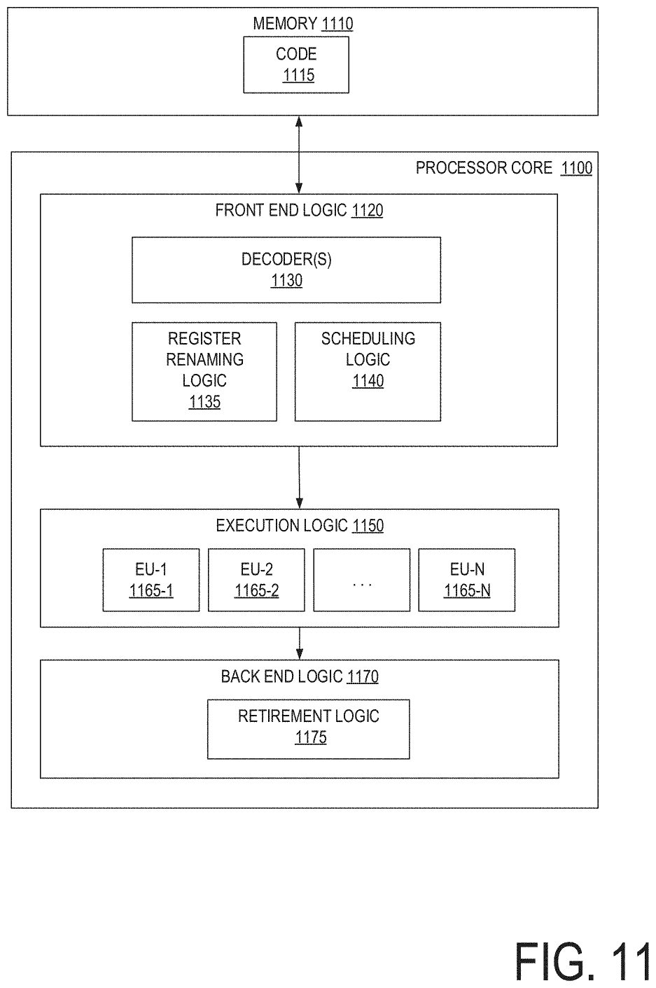

FIG. 11 is a block diagram of an exemplary processor core 1100 to execute computer-executable instructions as part of implementing technologies described herein. The processor core 1100 can be a core for any type of processor, such as a microprocessor, an embedded processor, a digital signal processor (DSP) or a network processor. The processor core 1100 can be a single-threaded core or a multithreaded core in that it may include more than one hardware thread context (or “logical processor”) per core.

FIG. 11 also illustrates a memory 1110 coupled to the processor 1100. The memory 1110 can be any memory described herein or any other memory known to those of skill in the art. The memory 1110 can store computer-executable instruction 1115 (code) executable by the processor core 1100.

The processor core comprises front-end logic 1120 that receives instructions from the memory 1110. An instruction can be processed by one or more decoders 1130. The decoder 1130 can generate as its output a micro operation such as a fixed width micro operation in a predefined format, or generate other instructions, microinstructions, or control signals, which reflect the original code instruction. The front-end logic 1120 further comprises register renaming logic 1135 and scheduling logic 1140, which generally allocate resources and queues operations corresponding to converting an instruction for execution.

The processor core 1100 further comprises execution logic 1150, which comprises one or more execution units (EUs) 1165-1 through 1165-N. Some processor core embodiments can include a number of execution units dedicated to specific functions or sets of functions. Other embodiments can include only one execution unit or one execution unit that can perform a particular function. The execution logic 1150 performs the operations specified by code instructions. After completion of execution of the operations specified by the code instructions, back-end logic 1170 retires instructions using retirement logic 1175. In some embodiments, the processor core 1100 allows out of order execution but requires in-order retirement of instructions. Retirement logic 1170 can take a variety of forms as known to those of skill in the art (e.g., re-order buffers or the like).

The processor core 1100 is transformed during execution of instructions, at least in terms of the output generated by the decoder 1130, hardware registers and tables utilized by the register renaming logic 1135, and any registers (not shown) modified by the execution logic 1150. Although not illustrated in FIG. 11, a processor can include other elements on an integrated chip with the processor core 1100. For example, a processor may include additional elements such as memory control logic, one or more graphics engines, I/O control logic and/or one or more caches.

As used in any embodiment herein, the term “module” refers to logic that may be implemented in a hardware component or device, software or firmware running on a processor, or a combination thereof, to perform one or more operations consistent with the present disclosure. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. As used in any embodiment herein, the term “circuitry” can comprise, for example, singly or in any combination, hardwired circuitry, programmable circuitry such as computer processors comprising one or more individual instruction processing cores, state machine circuitry, and/or firmware that stores instructions executed by programmable circuitry. Modules described herein may, collectively or individually, be embodied as circuitry that forms a part of one or more devices. Thus, any of the modules can be implemented as circuitry, such as stereoscopic content generation circuitry, revised stereoscopic generation circuitry, etc. A computer device referred to as being programmed to perform a method can be programmed to perform the method via software, hardware, firmware or combinations thereof.

Any of the disclosed methods can be implemented as computer-executable instructions or a computer program product. Such instructions can cause a computer or one or more processors that can execute computer-executable instructions to perform any of the disclosed methods. Generally, as used herein, the term “computer” refers to any computing device or system described or mentioned herein, or any other computing device. Thus, the term “computer-executable instruction” refers to instructions that can be executed by any computing device described or mentioned herein, or any other computing device.

The computer-executable instructions or computer program products as well as any data created and used during implementation of the disclosed technologies can be stored on one or more tangible or non-transitory computer-readable storage media, such as optical media discs (e.g., DVDs, CDs), volatile memory components (e.g., DRAM, SRAM), or non-volatile memory components (e.g., flash memory, solid state drives, chalcogenide-based phase-change non-volatile memories). Computer-readable storage media can be contained in computer-readable storage devices such as solid-state drives, USB flash drives, and memory modules. Alternatively, the computer-executable instructions may be performed by specific hardware components that contain hardwired logic for performing all or a portion of disclosed methods, or by any combination of computer-readable storage media and hardware components.

The computer-executable instructions can be part of, for example, a dedicated software application or a software application that is accessed via a web browser or other software application (such as a remote computing application). Such software can be read and executed by, for example, a single computing device or in a network environment using one or more networked computers. Further, it is to be understood that the disclosed technology is not limited to any specific computer language or program. For instance, the disclosed technologies can be implemented by software written in C++, Java, Perl, JavaScript, Adobe Flash, or any other suitable programming language. Likewise, the disclosed technologies are not limited to any particular computer or type of hardware.

Furthermore, any of the software-based embodiments (comprising, for example, computer-executable instructions for causing a computer to perform any of the disclosed methods) can be uploaded, downloaded or remotely accessed through a suitable communication technology. Such suitable communication technologies include, for example, the Internet, the World Wide Web, an intranet, cable (including fiber optic cable), magnetic communications, electromagnetic communications (including RF, microwave, and infrared communications), electronic communications, or other such communication technologies.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrase “at least one of A, B or C” can mean A; B; C; A and B; A and C; B and C; or A, B and C.

The disclosed methods, apparatuses and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to additional embodiments of technologies disclosed herein.

Example 1 is an apparatus comprising: a left image sensor; a left lens; a right image sensor; and a right lens; one or more processors; one or more computer-readable media having stored thereon instructions that when executed cause the one or more processors to: generate, using the left image sensor and the right image sensor, a stereoscopic image comprising a left image and a right image, the left image including a right lens artifact, the right image including a left lens artifact; and generate a revised stereoscopic image by replacing the right lens artifact with left image content that blends in with the left image and replacing the left lens artifact with right image content that blends in with the right image.

Example 2 is the apparatus of Example 1, wherein the replacing the right lens artifact comprises generating the left image content via inpainting and the replacing the left lens artifact comprises generating the right image content via inpainting.

Example 3 is the apparatus of Example 2, wherein a right lens mask defines the portion of the left image to be replaced with the left image content a left lens mask defines the portion of the right image to be replaced with the right image content.

Example 4 is the apparatus of Example 1, wherein the left image content is based on a right image portion of the right image corresponding to a location of the right lens artifact in the left image and the right image content is based on a left image portion of the left image corresponding to a location of the left lens artifact in the right image.

Example 5 is the apparatus of Example 4, wherein: the left image content is based on a transformation of the right image portion from an image space of the right image to an image space of the left image; and the right image data is based on a transformation of the left image portion from the image space of the left image to the image space of the right image.

Example 6 is the apparatus of Example 4, wherein: replacing the right lens artifact with the left image content comprises providing the right image portion to an inpainting model, wherein the left image data is based on the resulting output of the inpainting model; and replacing the left lens artifact with the right image content comprises providing the left image portion to the inpainting model, wherein the right image data is based on the resulting output of the inpainting model.

Example 7 is the apparatus of Example 1, wherein the apparatus further comprises a display, the one or more computer-readable media having stored thereon instructions that when executed further cause the one or more processors to cause the revised stereoscopic image to be shown on the display.

Example 8 is the apparatus of Example 7, wherein the revised stereoscope image shown on the display is an image in a revised stereoscopic video and the revised stereoscopic video is shown on the display in real time.

Example 9 is the apparatus of Example 1, wherein the left image comprises one or more additional feature artifacts, the one or more computer-readable media having stored thereon instructions that when executed further cause the one or more processors to replace the one or more additional feature artifacts with additional left image content that blends in with the left image.

Example 10 is the apparatus of Example 1, wherein the right image comprises one or more additional feature artifacts, the one or more computer-readable media having stored thereon instructions that when executed further cause the one or more processors to replace the one or more additional feature artifacts with additional right image content that blends in with the right image.

Example 11 is the apparatus of Example 1, wherein the apparatus is a head-mounted device or an optical head-mounted display device.

Example 12 is the apparatus of Example 1, wherein the apparatus further comprises an antenna, a battery, and a network interface.

Example 13 is the apparatus of Example 1, wherein the apparatus is a stereoscopic camera.

Example 14 is a computing device comprising: one or more processors; a display having a display field of view (FOV); and one or more computer-readable media having stored thereon instructions that when executed cause the one or more processors to: determine an orientation of the computing device; determine a portion of stereoscopic content to show on the display based on the orientation of the computing device, the stereoscopic content having a stereoscopic content FOV greater than the display FOV; if the portion of the stereoscopic content to show on the display includes at least a portion of a lens artifact, generate revised stereoscopic content by replacing the lens artifact with content that blends in with the stereoscopic content and show the revised stereoscopic content instead of the stereoscopic content on the display; and if the portion of the stereoscopic image to shown on the display does not include at least a portion of the lens artifact, show the stereoscopic image on the display.

Example 15 is a system comprising: one or more processors; one or more computer-readable media having stored thereon instructions that when executed cause the one or more processors to: generate a revised stereoscopic image from a stereoscopic image, the stereoscopic image comprising a left image and a right image, the left image including a right lens artifact, the right image including a left lens artifact, the generating comprising replacing the right lens artifact with left image content that blends in with the left image and replacing the left lens artifact with content that blends in with the right image; and store the revised stereoscopic image.

Example 16 is the system of Example 15, the one or more computer-readable media having stored thereon instructions that when executed further cause the one or more processors to: receive the stereoscopic image from a computing device; and send the revised stereoscopic image to the computing device.

Example 17 is the system of Example 15, wherein the replacing the right lens artifact comprises generating the left image content via inpainting and the replacing the left lens artifact comprises generating the right image content via inpainting.

Example 18 is the system of Example 17, wherein a right lens mask defines the portion of the left image to be replaced with the left image content a left lens mask defines the portion of the right image to be replaced with the right image content.

Example 19 is the system of Example 18, the one or more computer-readable media having stored thereon instructions that when executed further cause the one or more processors to receive right lens mask information describing the right lens mask and left lens mask information defining the left lens mask.

Example 20 is the system of Example 15, wherein the left image content is based on a right image portion of the right image corresponding to a location of the right lens artifact in the left image and the right image content is based on a left image portion of the left image corresponding to a location of the left lens artifact in the right image.

Example 21 is the system of Example 20, wherein: the left image content is based on a transformation of the right image portion from an image space of the right image to an image space of the left image; and the right image data is based on a transformation of the left image portion from the image space of the left image to the image space of the right image.

Example 22 is the system of Example 20, wherein: replacing the right lens artifact with the left image content comprises providing the right image portion to an inpainting model, wherein the left image data is based on the resulting output of the inpainting model; and replacing the left lens artifact with the right image content comprises providing the left image portion to the inpainting model, wherein the right image data is based on the resulting output of the inpainting model.

Example 23 is the system of Example 15, wherein the left image comprises one or more additional feature artifacts, the one or more computer-readable media having stored thereon instructions that when executed further cause the one or more processors to replace the one or more additional feature artifacts with additional left image content that blends in with the left image.

Example 24 is the system of Example 15, wherein the right image comprises one or more additional feature artifacts, the one or more computer-readable media having stored thereon instructions that when executed further cause the one or more processors to replace the one or more additional feature artifacts with additional right image content that blends in with the right image.

Example 25 is a stereoscopic content generation method comprising: generating, using a left image sensor and a right image sensor, a stereoscopic image comprising a left image and a right image, the left image including a right lens artifact, the right image including a left lens artifact; and generating a revised stereoscopic image by replacing the right lens artifact with left image content that blends in with the left image and replacing the left lens artifact with right image content that blends in with the right image.

Example 26 is the method of Example 25, wherein the replacing the right lens artifact comprises generating the left image content via inpainting and the replacing the left lens artifact comprises generating the right image content via inpainting.

Example 27 is the method of Example 25, wherein a right lens mask defines the portion of the left image to be replaced with the left image content a left lens mask defines the portion of the right image to be replaced with the right image content.

Example 28 is the method of Example 25, wherein the left image content is based on a right image portion of the right image corresponding to a location of the right lens artifact in the left image and the right image content is based on a left image portion of the left image corresponding to a location of the left lens artifact in the right image.

Example 29 is the method of Example 28, wherein: the left image content is based on a transformation of the right image portion from an image space of the right image to an image space of the left image; and the right image data is based on a transformation of the left image portion from the image space of the left image to the image space of the right image.

Example 30 is the method of Example 28, wherein: replacing the right lens artifact with the left image content comprises providing the right image portion to an inpainting model, wherein the left image data is based on the resulting output of the inpainting model; and replacing the left lens artifact with the right image content comprises providing the left image portion to the inpainting model, wherein the right image data is based on the resulting output of the inpainting model.

Example 31 is the method of Example 25, wherein the apparatus further comprises a display, the one or more computer-readable media having stored thereon instructions that when executed further cause the one or more processors to cause the revised stereoscopic image to be shown on the display.

Example 32 is the method of Example 25, wherein the revised stereoscope image shown on the display is an image in a revised stereoscopic video and the revised stereoscopic video is shown on the display in real time.

Example 33 is the method of Example 25, wherein the left image comprises one or more additional feature artifacts, the one or more computer-readable media having stored thereon instructions that when executed further cause the one or more processors to replace the one or more additional feature artifacts with additional left image content that blends in with the left image.

Example 34 is the apparatus of Example 25, wherein the right image comprises one or more additional feature artifacts, the one or more computer-readable media having stored thereon instructions that when executed further cause the one or more processors to replace the one or more additional feature artifacts with additional right image content that blends in with the right image.

Example 35 is a stereoscopic content display method comprising: determining an orientation of a device comprising a display having a display field of view (FOV); determining a portion of stereoscopic content to show on the display based on the orientation of the device, the stereoscopic content having a stereoscopic content FOV greater than the display FOV; if the portion of the stereoscopic image to show on the display includes at least a portion of a lens artifact, generating revised stereoscopic content by replacing the lens artifact with content that blends in with the stereoscopic content and showing the revised stereoscopic content instead of the stereoscopic content on the display; and if the portion of the stereoscopic image to shown on the display does not include at least a portion of the lens artifact, showing the stereoscopic image on the display.

Example 36 is a stereoscopic content generation method comprising: generating a revised stereoscopic image from a stereoscopic image captured using a left image sensor and a right sensor, the stereoscopic image comprising a left image and a right image, the left image including a right lens artifact, the right image including a left lens artifact, the generating comprising replacing the right lens artifact with left image content that blends in with the left image and replacing the left lens artifact with content that blends in with the right image; and storing the revised stereoscopic image.

Example 37 is the method of claim 36, the one or more computer-readable media having stored thereon instructions that when executed further cause the one or more processors to: receive the stereoscopic image from a computing device; and send the revised stereoscopic image to the computing device.

Example 38 is the method of claim 36, wherein the replacing the right lens artifact comprises generating the left image content via inpainting and the replacing the left lens artifact comprises generating the right image content via inpainting.

Example 39 is the method of claim 36, wherein a right lens mask defines the portion of the left image to be replaced with the left image content a left lens mask defines the portion of the right image to be replaced with the right image content.

Example 40 is the method of claim 39, the one or more computer-readable media having stored thereon instructions that when executed further cause the one or more processors to receive right lens mask information describing the right lens mask and left lens mask information defining the left lens mask.

Example 41 is the method of claim 39, wherein the left image content is based on a right image portion of the right image corresponding to a location of the right lens artifact in the left image and the right image content is based on a left image portion of the left image corresponding to a location of the left lens artifact in the right image.

Example 42 is the method of claim 41, wherein: the left image content is based on a transformation of the right image portion from an image space of the right image to an image space of the left image; and the right image data is based on a transformation of the left image portion from the image space of the left image to the image space of the right image.

Example 43 is the method of claim 41, wherein: replacing the right lens artifact with the left image content comprises providing the right image portion to an inpainting model, wherein the left image data is based on the resulting output of the inpainting model; and replacing the left lens artifact with the right image content comprises providing the left image portion to the inpainting model, wherein the right image data is based on the resulting output of the inpainting model.

Example 44 is the method of claim 36, wherein the left image comprises one or more additional feature artifacts, the one or more computer-readable media having stored thereon instructions that when executed further cause the one or more processors to replace the one or more additional feature artifacts with additional left image content that blends in with the left image.

Example 45 is the method of claim 36, wherein the right image comprises one or more additional feature artifacts, the one or more computer-readable media having stored thereon instructions that when executed further cause the one or more processors to replace the one or more additional feature artifacts with additional right image content that blends in with the right image.

Example 46 is one or more computer-readable storage media having instructions stored thereon that when executed cause one or more processors to perform the method of any of the claims 25-45.

Example 47 is an apparatus comprising means to perform a method as claimed in any of the claims 25-45.

I claim:

1. An apparatus comprising:
a left image sensor;
a left lens;
a right image sensor;
a right lens;
one or more processors;
one or more computer-readable media having stored thereon instructions that when executed cause the one or more processors to:
generate, using the left image sensor and the right image sensor, a stereoscopic image comprising a left image and a right image, the left image including a right lens artifact, the right image including a left lens artifact; and
generate a revised stereoscopic image by replacing the right lens artifact with left image content that blends in with the left image and replacing the left lens artifact with right image content that blends in with the right image.

2. The apparatus of claim 1, wherein the replacing the right lens artifact comprises generating the left image content via inpainting and the replacing the left lens artifact comprises generating the right image content via inpainting.

3. The apparatus of claim 2, wherein a right lens mask defines the portion of the left image to be replaced with the left image content a left lens mask defines the portion of the right image to be replaced with the right image content.

4. The apparatus of claim 1, wherein the left image content is based on a right image portion of the right image corresponding to a location of the right lens artifact in the left image and the right image content is based on a left image portion of the left image corresponding to a location of the left lens artifact in the right image.

5. The apparatus of claim 4, wherein:
the left image content is based on a transformation of the right image portion from an image space of the right image to an image space of the left image; and
the right image data is based on a transformation of the left image portion from the image space of the left image to the image space of the right image.

6. The apparatus of claim 4, wherein:
replacing the right lens artifact with the left image content comprises providing the right image portion to an inpainting model, wherein the left image data is based on the resulting output of the inpainting model; and
replacing the left lens artifact with the right image content comprises providing the left image portion to the inpainting model, wherein the right image data is based on the resulting output of the inpainting model.

7. The apparatus of claim 1, wherein the apparatus further comprises a display, the one or more computer-readable media having stored thereon instructions that when executed further cause the one or more processors to cause the revised stereoscopic image to be shown on the display.

8. The apparatus of claim 1, wherein the apparatus is a stereoscopic camera.

9. The apparatus of claim 1, wherein the apparatus further comprises an antenna, a battery, and a network interface.

10. A stereoscopic content generation method comprising:
generating, using a left image sensor and a right image sensor, a stereoscopic image comprising a left image and a right image, the left image including a right lens artifact, the right image including a left lens artifact; and
generating a revised stereoscopic image by replacing the right lens artifact with left image content that blends in with the left image and replacing the left lens artifact with right image content that blends in with the right image.

11. The method of claim 10, wherein the replacing the right lens artifact comprises generating the left image content via inpainting and the replacing the left lens artifact comprises generating the right image content via inpainting.

12. The method of claim 11, wherein a right lens mask defines the portion of the left image to be replaced with the left image content a left lens mask defines the portion of the right image to be replaced with the right image content.

13. The method of claim 11, wherein the left image content is based on a right image portion of the right image corresponding to a location of the right lens artifact in the left image and the right image content is based on a left image portion of the left image corresponding to a location of the left lens artifact in the right image.

14. The method of claim 13, wherein:
the left image content is based on a transformation of the right image portion from an image space of the right image to an image space of the left image; and
the right image data is based on a transformation of the left image portion from the image space of the left image to the image space of the right image.

15. The method of claim 13, wherein:
replacing the right lens artifact with the left image content comprises providing the right image portion to an inpainting model, wherein the left image data is based on the resulting output of the inpainting model; and
replacing the left lens artifact with the right image content comprises providing the left image portion to the inpainting model, wherein the right image data is based on the resulting output of the inpainting model.

16. The method of claim 10, wherein the apparatus further comprises a display, the one or more computer-readable media having stored thereon instructions that when executed further cause the one or more processors to cause the revised stereoscopic image to be shown on the display.

17. The method of claim 10, wherein the revised stereoscope image shown on the display is an image in a revised stereoscopic video and the revised stereoscopic video is shown on the display in real time.

18. One or more computer-readable storage media having instructions stored thereon that when executed cause one or more processors to perform a method comprising:
generating, using a left image sensor and a right image sensor, a stereoscopic image comprising a left image and a right image, the left image including a right lens artifact, the right image including a left lens artifact; and
generating a revised stereoscopic image by replacing the right lens artifact with left image content that blends in with the left image and replacing the left lens artifact with right image content that blends in with the right image.

19. The one or more computer-readable storage media of claim 18, wherein the replacing the right lens artifact comprises generating the left image content via inpainting and the replacing the left lens artifact comprises generating the right image content via inpainting.

20. The one or more computer-readable storage media of claim 18, wherein a right lens mask defines the portion of the left image to be replaced with the left image content a left lens mask defines the portion of the right image to be replaced with the right image content.

21. The one or more computer-readable storage media of claim 18, wherein the left image content is based on a right image portion of the right image corresponding to a location of the right lens artifact in the left image and the right image content is based on a left image portion of the left image corresponding to a location of the left lens artifact in the right image.

22. The one or more computer-readable storage media of claim 21, wherein:
replacing the right lens artifact with the left image content comprises providing the right image portion to an inpainting model, wherein the left image data is based on the resulting output of the inpainting model; and
replacing the left lens artifact with the right image content comprises providing the left image portion to the inpainting model, wherein the right image data is based on the resulting output of the inpainting model.

23. The one or more computer-readable storage media of claim 18, wherein the apparatus further comprises a display, the one or more computer-readable media having stored thereon instructions that when executed further cause the one or more processors to cause the revised stereoscopic image to be shown on the display.

24. An apparatus comprising:
a left image sensor;
a left lens;
a right image sensor;
a right lens;
a stereoscopic image capture means to capture a stereoscopic image comprising a left image and a right image, the left image including a right lens artifact, the right image including a left lens artifact; and
a revised stereoscopic content generation means to generate revised stereoscopic image by replacing the right lens artifact with left image content that blends in with the left image and replacing the left lens artifact with right image content that blends in with the right image.

25. The apparatus of claim 24, wherein the apparatus is a head-mounted device or an optical head-mounted display device.
